(19) United States
(12) Patent Application Publication
(10) Pub. No.: US 2015/0309515 A1
(43) Pub. Date: Oct. 29, 2015

(54) DUAL PRESSURE SHUTTLE VALVE

(71) Applicant: Proserv Operations, Inc., Houston, TX (US)

(72) Inventor: Andrew J. Patterson, Katy, TX (US)

(73) Assignee: PROSERV OPERATIONS, INC., Houston, TX (US)

(21) Appl. No.: 14/264,669

(22) Filed: Apr. 29, 2014

(51) Int. Cl. G05D 16/10

(52) U.S. Cl. CPC G05D 16/103

(57) ABSTRACT

A dual pressure shuttle valve assembly is arranged to operate at two different supply pressures and sequence the flow from the two supplies such that the first lower pressure fluid supply is consumed before the second higher pressure fluid supply is utilized in order to maximize downstream function pressure. The shuttle valve assembly includes a shuttle assembly with opposition portions having different valve seat diameters, and having differently sized apertures.

### BACKGROUND OF THE INVENTION

The present invention generally relates to a dual pressure shuttle valve. More specifically, the present invention relates to a shuttle valve having a shuttle assembly that will operate with two different pressures activated at two different inlet ports.

The Applicant hereof has been producing shuttle valves for use in the subsea production of oil and gas for a number of years. For example, see U.S. Pat. No. 6,318,400 (hereinafter '400 Patent) and U.S. Pat. No. 6,257,268 (hereinafter '268 Patent) both of which are incorporated herein for all purposes. Shuttle valves may operate based on differential pressure or flow. In this industry, it is common to refer to shuttle valves that operate based on differential pressure as “pressure biased shuttle valves.” It is also common to refer to shuttle valves that operate based on differential flow as “spring biased shuttle valves,” although both types may include a spring. Common shuttle valves operate with pressure only applied to one of two inlet ports.

The present invention is a new type of shuttle valve that will operate with both inlet ports pressurized.

### A. Differential Pressure Type Shuttle Valves

Pressure biased shuttle valves, such as described in the '268 Patent operate with relatively low flow rates. In both the “pressure biased shuttle valves” and “spring biased shuttle valves” the spring forces the shuttle to return to a known default position at either a known differential pressure or flow rate.

### B. Differential Flow Type Shuttle Valves

Prior art differential flow type shuttle valves that operate based on differential flow, such as that shown in FIG. 1, tend to operate with relatively high flow rates. FIG. 1 illustrates a prior art differential flow shuttle valve which is capable of having a flow rate of 250 GPM through one port and 50 GPM through the other port, due to flow restrictions in the other port. As can be seen, prior art shuttle valve 1 includes a body 10 having a shuttle 15 therein. The shuttle includes opposing stub portions 18, each of which includes apertures 19. A first adapter 20 and second adapter 30 are engaged with the body 10. As illustrated, first adapter 20 may be a small adapter, while second adapter 30 may be a long adapter. As shown, the diameter 40 of the first valve seat of the short adapter 20 is generally the same as the diameter 45 of the second valve seat of the long adapter 30. Further, apertures 19 and stub portions 18 are generally of the same size.

Many existing subsea production systems use early prior art shuttle valves of the '400 Patent that have equal fluid flow through all ports. The overall hydraulic system of a lower marine riser platform (LMRP) is designed based in part on the flow characteristics of these prior art shuttle valves. Any change in these flow characteristics will be unacceptable because it is disruptive to the hydraulic system already in place. These prior art shuttle valves operate with equal pressure at the first and second supply ports.

The recent prior art has equal flow rates through all ports, unlike some prior art designs, as shown in FIG. 2. This prior art can be exchanged with some prior art shuttle valves in existing LMRPs of the '400 patent without changing the overall flow characteristics of the subsea system. In order to be a candidate for an exchange, the differential flow type shuttle valve must produce equal flow through all ports.

### C. Dual Pressure Type Shuttle Valves

All types of prior art shuttle valves operate with equal pressure at the first and second supply ports. There is a need for a new shuttle valve that is designed to operate with different pressures at the first and second supply ports, and is designed to sequence the flow of the first low pressure port and second high pressure port, thereby allowing the operator to continue using existing low pressure HPU equipment, and reducing the cost of installation of new high pressure HPU equipment.

### D. More Recent Prior Art Flow Differential Shuttle Valves

More recently, prior art flow differential shuttle valves have been created which have flow rates of 250 gpm through both inlet ports, as no flow restrictions exist in the ports. FIGS. 3-5 illustrate an example prior art shuttle valve 300 of this type, in various positions. FIG. 3 illustrates the prior art shuttle valve 300 in its default position. As can be seen, shuttle valve 300 still includes a body 310 having a shuttle 315 therein. Rather than two similar stub portions, shuttle 315 includes a stub portion 318A opposing an elongate portion 318B. The first adapter 320 and second adapter 330 are engaged with the body 310 via the stub portion 318A and elongate portion 318B, respectively. As illustrated, first adapter 320 may be a small adapter, while second adapter 330 may be a long adapter. The stub portion 318A and elongate portion 318B still include similarly sized apertures 319. Further, the diameter 340 of the first valve seat of the short adapter 320 is generally the same as the diameter 345 of the second valve seat of the long adapter 330.

At rest, spring 350 of the long adapter 330 biases the shuttle toward the long adapter, as shown in FIG. 3. By default, flow between the short adapter and the outlet occurs when the short adapter is pressurized and vented. When the long adapter is pressurized with the short adapter vented, the pressure from the long adapter 330 is able to overcome the force exerted by the spring. Thus, FIG. 4 shows the shuttle 315 in its intermediate position, shifting away from its default position. FIG. 5 shows the shuttle 315 having shifted fully, such that it is now blocking flow from the shot adapter 320 and is allowing flow through the long adapter 330. Once the pressure through the long adapter 330 wanes, such pressure would no longer be able to overcome the force of spring 350, and the shuttle 315 would shift back through the intermediate position shown in FIG. 4 to the default position shown in FIG. 3.

### SUMMARY OF THE PRESENT INVENTION

There is a need for a new dual pressure type shuttle valve in many drilling and production control systems, topside and subsea, as represented in the present invention.

In one embodiment a shuttle valve body is designed for engagement with a first adapter and a second adapter. The shuttle body comprising an outlet port and a shuttle. The shuttle includes a first portion for engagement with the first adapter, and the first portion has first apertures. The first portion is preferably sized to slide at least partially within a first valve seat of the first adapter. Further, the shuttle includes a second portion for engagement with the second adapter, and the second portion has second apertures. The second portion is preferably sized to slide at least partially within a second valve seat of the second adapter. Further, the first apertures are smaller than the second apertures. Additionally, the first valve seat has a diameter larger than the diameter of the second valve seat such that the first portion has a larger diameter than the second portion.

In another embodiment, a shuttle valve comprises a first adapter having a first valve seat with a first diameter, as well as a second adapter having a second valve seat with a second diameter. Preferably, the first diameter is larger than the second diameter. The shuttle valve also includes a body which is operationally attached to the first adapter and second adapter. The body preferably includes an outlet port and a shuttle. The shuttle preferably includes a first portion for engagement with the first adapter, and the first portion has first apertures. The shuttle also preferably includes a second portion for engagement with the second adapter, and the second portion has second apertures. Preferably, the first apertures are smaller than the second apertures.

In another embodiment, a shuttle valve is adapted for use with pressurized fluid sources of varying pressures. The valve includes a body having a pair of opposing coaxial adapter ports, a transverse function port, and a passageway allowing fluid communication between all of the ports. Each adapter port is preferably in fluid communication with one of the fluid sources, and the function port is preferably in fluid communication with the downstream apparatus. The valve also includes an adapter functionally attached to the adapter port. The adapter preferably has a first valve seat at one end and an inlet port at an opposing end, with a bore therebetween to permit fluid flow from the inlet port past the first valve seat. The shuttle valve also includes a shuttle valve assembly, which has an elongate tubular adapter engaging the other adapter port. The elongate tubular adapter preferably has a second valve seat at one end and an inlet port at another end, with a central bore in between to permit fluid flow from the inlet port past the second valve seat. A shuttle is preferably coaxial with the first valve seat and the second valve seat, and is slideably movable from sealing engagement with the first valve seat to sealing engagement with the second valve seat. The shuttle preferably has an elongate portion and an opposing stub portion. The shuttle also includes a guide functionally attached to an elongate end of the shuttle, and the guide is sized and arranged to slide into the elongate tubular adapter. A spring is preferably positioned in the elongate tubular adapter and surrounding the elongate portion of the shuttle, captured between the guide and a shoulder in the central bore of the elongate tubular adapter. The spring thereby urges the shuttle into sealing engagement with the second valve seat in a default position. Further, the short portion of the shuttle has a hollow center, an open end and at least one aperture to generate substantial flow friction such that the force of the spring is substantially exceeded when the second valve seat is engaged, as fluid from the inlet port on the short adapter occurs across the hollow center in the short adapter past the first valve seat as compared with fluid flow through the second inlet port and past the second valve seat. The elongate portion of the shuttle also has a hollow center, as well as an open end and at least one aperture proximate the spring, all to allow a substantial flow of fluid from the inlet port on the elongate tubular adapter through the hollow center in the elongate tubular adapter past the second valve seat. The shuttle further includes a circumferential collar portion which has an outer diameter that produces a pressure controlled area on the elongated portion of the shuttle between the starting position of the shuttle, with low pressure fluid flowing, and the mid position of the shuttle, with low pressure fluid flow diminished.

The dual pressure type shuttle valve of the present invention operates based on both differential pressure and differential flow and with pressure acting on both inlets simultaneously, versus pressure only as in the '268 patent, or flow only as in the differential flow shuttle valve prior art discussed above and below. The present invention preferably has unequally sized valve seats, which preferably operate at unequal pressures, as well as differently sized apertures in the first and second adapters.

### BRIEF DESCRIPTION OF THE DRAWINGS

FIG. 1 illustrates a cross-sectional view of a prior art shuttle valve.

FIG. 2 illustrates a cross-sectional view of another prior art shuttle valve.

FIG. 3 illustrates a cross-sectional view of yet another prior art shuttle valve, in its default position.

FIG. 4 illustrates a cross-sectional view of the prior art shuttle valve of FIG. 3, as the shuttle is shifting positions.

FIG. 5 illustrates a cross-sectional view of the prior art shuttle valve of FIGS. 3 and 4, after the shuttle has fully shifted.

FIG. 6 illustrates a cross-section view of a dual pressure shuttle valve according to an embodiment of the present invention.

FIG. 7 illustrates an enlarged cross-section view of the body and shuttle of the dual pressure shuttle valve of FIG. 6.

FIG. 8 illustrates an enlarged cross-sectional view of a seal between a valve seal and valve seat in the dual pressure shuttle valve of FIG. 6, also illustrating a chamfer.

FIG. 9 illustrates a cross-sectional view of the dual pressure shuttle valve of FIG. 6, as the shuttle is shifting positions.

FIG. 10 illustrates a cross-sectional view of the dual pressure shuttle valve of FIGS. 6 and 9, after the shuttle has fully shifted.

FIG. 11 illustrates a cross-section view of a repair/replacement kit according to one embodiment of the present invention.

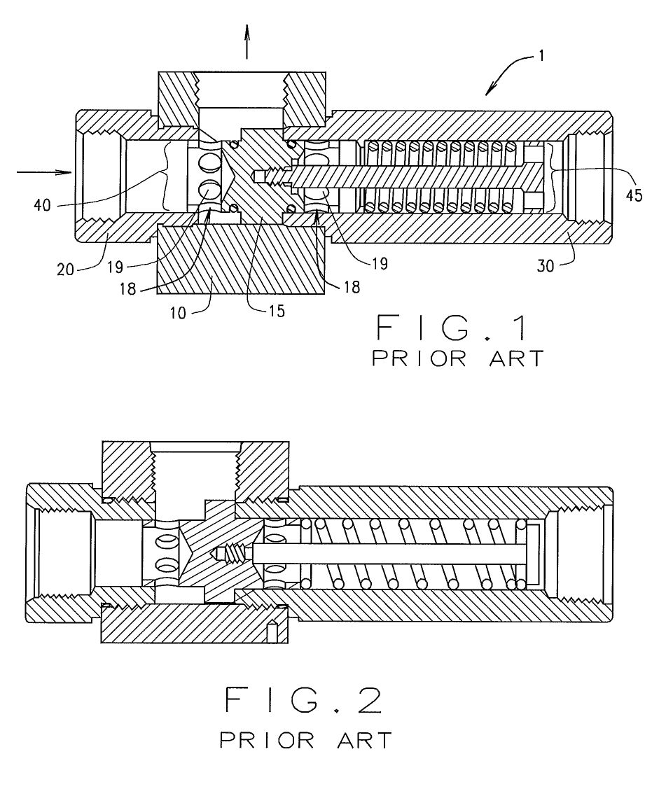

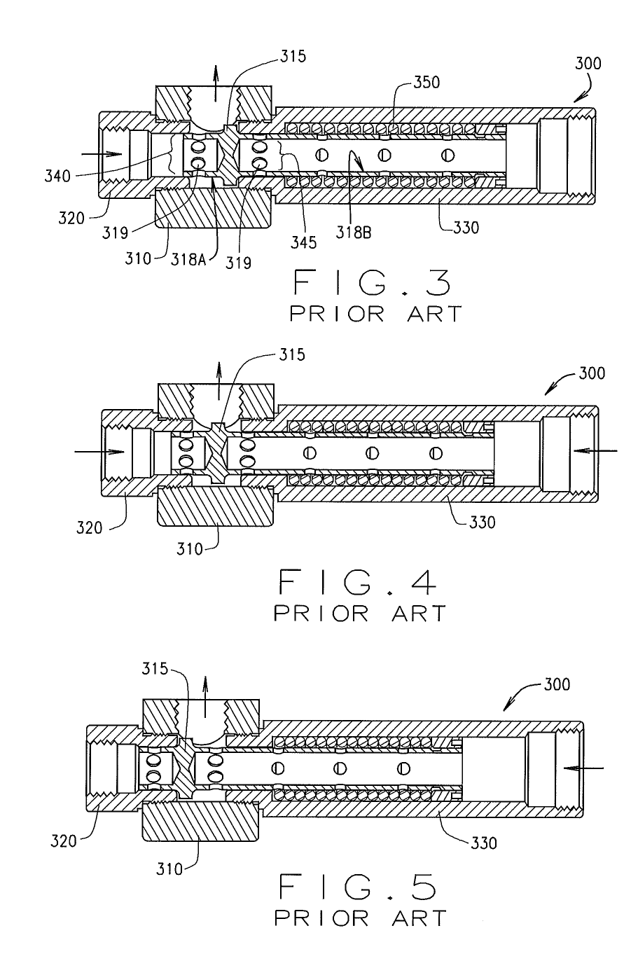

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure as defined by the appended claims.

### DETAILED DESCRIPTION OF THE DRAWINGS

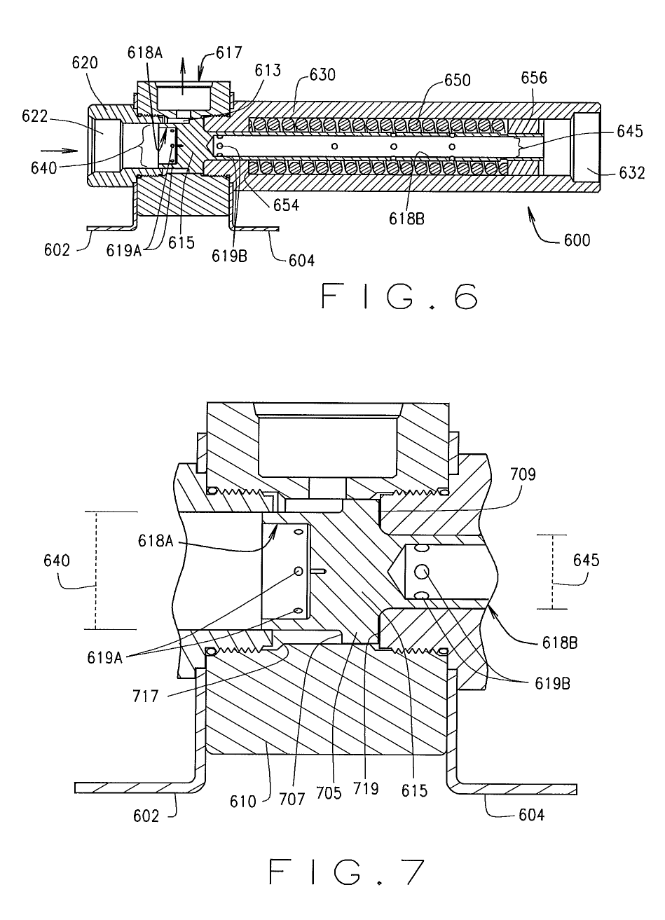

FIG. 6 illustrates a cross-sectional view of an embodiment of the dual pressure type shuttle valve 600 of the present invention. The present invention may be used to replace one of more of the stacked shuttle valves from patent '400 shown in FIG. 11 and FIG. 12. This shuttle valve is capable of having a starting flow rate of about 100 GPM through a low pressure port, and an ending flow rate of 200 GPM through a high pressure port. Shuttle valve 600 may include a first bracket 602 and a second bracket 604 to support the valve 600 and facilitate attachment to other apparatus.

The shuttle valve 600 includes a body 610 having a shuttle assembly 615 and an outlet port 617. FIG. 7 illustrates an enlarged view of body 310 and shuttle assembly 615, and will be discussed in detail below. As can be seen in FIG. 6, body 610 is sized and arranged to receive a first adapter 620. The first adapter 620 may be a short adapter, and is functionally attached to the body 610. The functional attachment may be achieved by threads as shown, or otherwise such as by welding or by bolts. The first adapter 620 defines a low pressure supply port 622. A second long adapter 630 is also functionally attached to the body 610. The functional attachment may be achieved by threads, as shown or otherwise for example by welding or by bolts. The second long adapter defines a high pressure supply port 632. A passageway 613 in the body 610 allows fluid to flow from the supply ports 622, 632 to the function or outlet port 617 in the valve body 610.

Shuttle 615 includes a generally hollow stub portion 618A for allowing fluid to flow from the low pressure inlet 622 to the outlet port 617. Shuttle 615 also includes a generally hollow long portion 618B for allowing fluid to flow from the high pressure port 632 to the outlet port 617. A spring 650 surrounds the long portion 618B of the shuttle 615. The force of the spring 650 may vary depending on the size of the shuttle valve 600 and the system into which the shuttle valve 600 will be placed. For example, in a one inch valve, the spring rate may be 660 pounds/inch. The spring is trapped between a shoulder 654 formed in the second adapter 630 and a guide 656. In this figure, the guide 656 is a threaded nut that threadably engages the long portion 318B of the shuttle 615. This allows the spring 650 to bias the shuttle 615.

As can best be seen in FIG. 7, shuttle 615 includes a central circumferential collar 705. The circumferential collar 705 slides within the body 610 forming a pressure controlling boundary. For example, in a one & one-half inch valve, the radial clearance to the body may be 0.005 inches. The radial clearance to the body may be larger or smaller depending on the size of the shuttle valve assembly and the system into which the shuttle valve will be placed. The side of the collar 705 facing the short adapter 620 forms a first valve seal 707 which seals against the first valve seat 717 of the short adapter 620. Similarly, the side of the collar 705 facing the long adapter 630 forms a second valve seal 709 which seals against the second valve seat 719. As can be seen, the diameter 640 of the first valve seat 717 is larger than the diameter 645 of the second valve seat 719. The side of collar 705 facing the long adapter 630 is therefore larger than the side of the collar 705 facing the short adapter 620. The first valve seat 617 may be substantially larger than the second valve seat 619. For example, in a one & one-half inch valve, the first valve seat diameter 640 may be one-half inch larger than the second valve seat diameter 645. The difference in the first and second seat diameters 640, 645 may be larger or smaller depending on the size of the shuttle valve 600 and the system into which the shuttle valve 600 will be placed. The difference in the diameters of the first and second valve seat diameters 640, 645 may be larger or smaller depending on the inlet pressures, flow rates, etc.

FIG. 7 also shows the stub portion 618A and a section of the long portion 618B of the shuttle 615. The stub portion 618A includes first apertures 619A, while the long portion 618B includes second apertures 619B. As can be seen, the first apertures 619A are smaller than the second apertures 619B. Apertures 619A are preferably equally spaced from one another, and may have diameters of about 0.125 inches for proper fluid friction and to achieve the required low pressure flow rate. Apertures 619B are also preferably equally spaced from one another, but may have diameters of about 0.250 inches to achieve the proper high pressure flow rate. The difference in the diameters of the first and second apertures 619A, 619B may be larger or smaller depending on the inlet pressures, flow rates, etc.

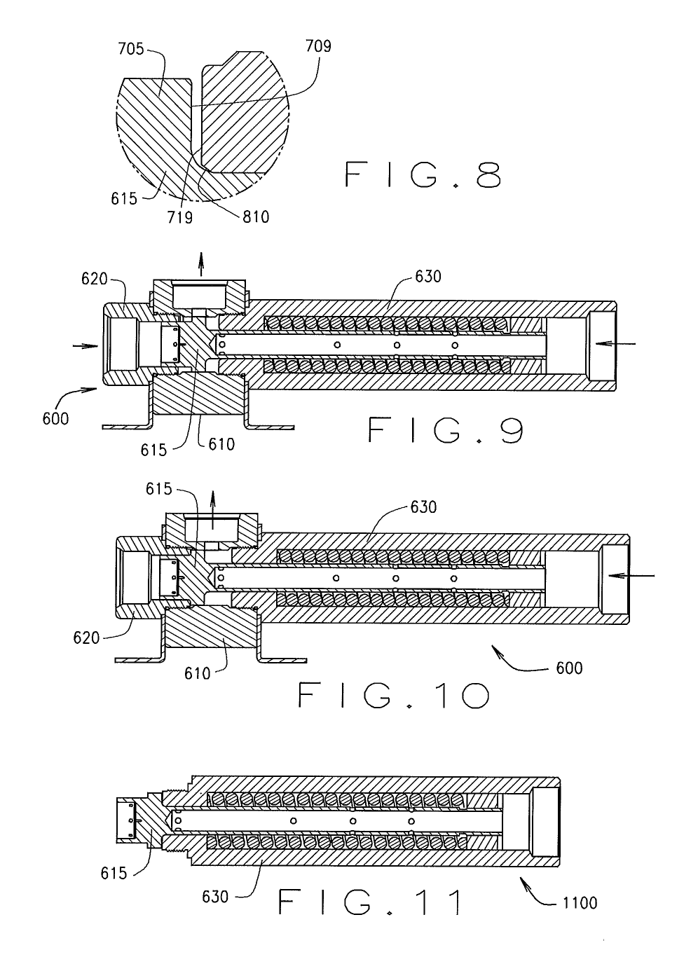

FIG. 8 is an enlarged view of the second valve seal 709 on the shuttle 615 and the second valve seat 719 on the elongate adapter 630 in sealing engagement as shown in FIGS. 6 and 7. The point of contact between these two metal surfaces is the second valve seal 709 on the shuttle 615 and the second valve seat 719 on the elongate adapter 630. Both the first and second valve seals 707, 709 on the shuttle 615 may be formed, for example, by a 0.125 inch blended radius. Other dimensions may also be suitable to achieve this metal to metal seal. Again, the second valve seal 709 is longer than the first valve seal 707. The first valve seat 717 on the first adapter 620 and the second valve seat 619 on the second elongate adapter 619 are formed in one embodiment by a 0.090 inch×20° chamfer 810 with a 0.020 inch blended radius at the large end of the chamfer. Other dimensions may also be suitable to achieve this metal to metal seal. In the alternative, the metal to metal seal between the shuttle 615 and the valve seats 617, 619 on the adapters 620, 630 may be formed by coining as described and shown in FIGS. 9 and 10 of the '400 Patent which is incorporated herein for all purposes.

As noted above, FIG. 6 shows the valve 600 in its default position with the shuttle 615 biased toward the long adapter 630 by spring 650. FIG. 6 also shows the fully pressurized position of the valve 600. When lower pressure fluid is flowing through the first supply port 622 and out the function port 617, the resulting fluid friction force acting on the shuttle 615 combined with the force from spring 650 is large enough to overcome higher pressure fluid at the second supply port 632 (which may be, for example, is 1000 psi more that the pressure at the first supply port) to maintain shuttle position. When the fluid friction force is reduced as the lower pressure fluid flow is reduced, or consumed, the combined forces are no longer adequate to maintain the shuttle position.

Preferably, the lower pressure side is pressurized first, and then the higher pressure side, so as to maintain the shuttle 615 in its default position. Therefore, in FIG. 6, flow passes from the low pressure inlet 622 through the apertures 619A, and out through the outlet port 617. Flow from the high pressure inlet 632 is blocked by the second valve seal 709 sealing against the second valve seat 619.

FIG. 9 shows the valve 600 as the pressure and flow from the low pressure inlet 622 diminishes to zero. As can be seen, in response to the reduced fluid friction force from the waning low pressure, the force from the high pressure inlet 632 becomes sufficient to overcome the force of the spring 650 and the waning low pressure flow from the low pressure port 622. Thus, the shuttle 615 begins to shift toward the first adapter 620. As shown in FIG. 9, flow is flowing through both inlet ports 622, 632 to the outlet port 617.

FIG. 10 shows the valve 600 with the shuttle 615 fully sealed against the first adapter 620. In this position, the first valve seal 707 is sealed against the first valve seat 617. Thus, flow passes from the high pressure inlet 632 through the apertures 619B, and out through the outlet port 617 while flow from the low pressure inlet 622 is blocked. This will generally occur until the downstream function (not shown) vents the higher pressure fluid.

The sequence discussed above then happens in reverse. The high pressure fluid is vented until the fluid friction force flowing through the larger apertures 619B is insufficient to overcome the force of spring 650 (at this point, there is materially no flow or force from the low pressure inlet 620). Thus, the high pressure will vent, followed by the shuttle 615 being forced back to its default position as shown in FIGS. 9 and eventually 6. At FIG. 6, the low pressure side is vented.

Referring to FIG. 11 a shuttle valve repair/replacement kit 1100 is shown in section view. The kit 1100 may be used for repair and/or maintenance to replace prior art shuttle valves such as those discussed above. In addition, this shuttle valve kit 1100 may be used to replace worn shuttle valve assemblies of the present invention. Shuttle valve kit 1100 is effectively a shuttle assembly 615 engaged with a long adapter 630. Kit 1100 can thereby replace an existing shuttle assembly and second adapter in an existing valve.

Thus, there has been shown and described several embodiments of a novel dual pressure shuttle valve. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A shuttle valve body for engagement with a first adapter and a second adapter, the shuttle body comprising:
an outlet port and a shuttle, the shuttle including:
a first portion for engagement with the first adapter, the first portion having first apertures, said first portion sized to slide at least partially within the first adapter such that a first valve seal on the shuttle is selectively sealingly engageable with a first valve seat of the first adapter;
a second portion for engagement with the second adapter, the second portion having second apertures, said second portion sized to slide at least partially within the second adapter such that a second valve seal on the shuttle is selectively sealingly engageable with a second valve seat of the second adapter;
wherein the first apertures are smaller than the second apertures; and
wherein the first valve seat has a diameter larger than the diameter of the second valve seat such that the first portion is has a larger diameter than the second portion.

2. The shuttle valve body of claim 1 wherein the body includes threads for threaded engagement with the first adapter.

3. The shuttle valve body of claim 1 wherein the body includes threads for threaded engagement with the second adapter.

4. The shuttle valve body of claim 1 wherein the second portion being elongate.

5. The shuttle valve body of claim 1 wherein a spring extends around the second portion to bias the shuttle into a seal with the second adapter.

6. The shuttle valve body of claim 5 wherein pressure from the first adapter combined with pressure exerted by the spring on the shuttle is greater than pressure from the second adapter, such that the shuttle seals against the second adapter when both the first and second adapters are fully pressurized.

7. The shuttle valve body of claim 5 wherein pressure from the second adapter on the shuttle is sufficient to overcome pressure exerted by the spring, such that the shuttle seals against the first adapter when the second adapters is fully pressurized but the first adapter is not pressurized.

8. The shuttle valve body of claim 1 wherein the shuttle includes a circumferential collar.

9. The shuttle valve body of claim 8 wherein one side of the circumferential collar forms the first valve seal, and the opposing side of the circumferential collar forms the second valve seal.

10. A shuttle valve comprising:
a first adapter having a first valve seat with a first diameter;
a second adapter having a second valve seat with a second diameter, wherein the first diameter is larger than the second diameter;
a body operationally attached to the first adapter and second adapter, the body including an outlet port and a shuttle, the shuttle including:
a first portion for engagement with the first adapter, the first portion having first apertures;
a second portion for engagement with the second adapter, the second portion having second apertures, wherein the first apertures are smaller than the second apertures.

11. A shuttle valve adapted for use with pressurized fluid sources of varying pressures, the valve comprising:
a body having a pair of opposing coaxial adapter ports, a transverse function port, and a passageway allowing fluid communication between all of the ports, each adapter port in fluid communication with one of the fluid sources and the function port in fluid communication with the downstream apparatus;
an adapter functionally attached to a first of the adapter port, the adapter having a first valve seat at one end and a inlet port at an opposing end, with a bore therebetween to permit fluid flow from the inlet port past the first valve seat;
a shuttle valve assembly including;
i. an elongate tubular adapter engaging the other adapter port, the elongate tubular adapter having a second valve seat at one end and an inlet port at another end, with a central bore in between to permit fluid flow from the inlet port past the second valve seat;
ii. a shuttle coaxial with the first valve seat and the second valve seat, the shuttle slideably moving from alternative sealing engagement with the first valve seat to sealing engagement with the second valve seat, the shuttle having an elongate portion and an opposing stub portion;
iii. a guide functionally attached to an elongate end of the shuttle, the guide sized and arranged to slide in the elongate tubular adapter;
iv. a spring positioned in the elongate tubular adapter and surrounding the elongate portion of the shuttle, the spring captured between the guide and a shoulder in the central bore of the elongate tubular adapter, the spring urging the shuttle into sealing engagement with the second valve seat; and
v. the short portion of the shuttle having a hollow center, an open end and at least one aperture, to generate substantial flow friction such that the force of the spring is substantially exceeded when the second valve seat is engaged, as fluid from the inlet port on the short adapter occurs across the hollow center in the short adapter past the first valve seat as compared with fluid flow through the second inlet port and past the second valve seat.
vi. the elongate portion of the shuttle having a hollow center, an open end and at least one aperture proximate the spring, all to allow a substantial flow of fluid from the inlet port on the elongate tubular adapter through the hollow center in the elongate tubular adapter past the second valve seat.
vii. a circumferential collar portion of the shuttle having an outer diameter that produces a pressure controlled area on the elongated portion of the shuttle between the starting position of the shuttle, with low pressure fluid flowing, and the mid position of the shuttle, with low pressure fluid flow diminished.
